(19) United States
(12) Patent Application Publication
(10) Pub. No.: US 2010/0169156 A1
(43) Pub. Date: Jul. 1, 2010

(54) SYSTEM AND METHOD FOR CREDITING A CUSTOMER ACCOUNT

(76) Inventor: Pamela K. Gustafson, Overland Park, KS (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(21) Appl. No.: 12/346,217

(22) Filed: Dec. 30, 2008

(51) Int. Cl. G06Q 30/00; G06Q 50/00; G06Q 10/00

(52) U.S. Cl. 705/10; 705/30; 705/14.4

(57) ABSTRACT

Embodiments of the disclosed invention include a system and method for crediting a customer account for having placed a call from the customer on hold during a customer service call. For example, in one embodiment, audible advertisements are played while a customer is on hold during a customer service call. Revenue received from the advertisers associated with the audible advertisements is used to credit the customer account. In some embodiments, the total credit applied to customer accounts for having been placed on hold completely offsets all revenue received from the advertisers of the audible advertisements. Thus, the disclosed embodiments provide a mutual benefit to advertisers and consumers.

### BACKGROUND OF THE INVENTION

Customer service is the provision of service to customers before, during, and after a purchase. Customer service is an integral part of a company's customer value proposition. However, the quality and level of customer service has decreased in recent years. For example, many customer service call lines are answered by an interactive voice response system instead of a live person. In addition, consumers are often placed on hold for an exorbitant amount of time prior to a live person answering and/or during a customer service call.

### SUMMARY OF THE INVENTION

Embodiments of the disclosed invention include a system and method for crediting a customer account for having placed a call from the customer on hold during a customer service call. For example, in one embodiment, a computer implemented method is presented that includes receiving an incoming call to a customer service line and determining a caller identification associated with the incoming call. The method determines whether the caller identification is associated with a customer account. The method monitors the incoming call to determine whether the incoming call is placed on a hold state. In response to a determination that the incoming call is placed on the hold state; the method initiates a timer to monitor an amount of time the incoming call is placed on the hold state. In response to a determination that the incoming call is taken off the hold state, the method calculates a credit amount based having placed the incoming call from the customer on the hold state. The method applies the credit amount to the customer account.

Further details and advantages of the present invention will be discussed in the following detailed description of the preferred embodiments.

### BRIEF DESCRIPTION OF THE DRAWINGS

For a more complete understanding of the present application, the objects and advantages thereof, reference is now made to the following descriptions taken in conjunction with the accompanying drawings, in which:

FIG. 1 depicts one embodiment of a network environment in which the illustrative embodiments may be implemented;

FIG. 2 depicts an embodiment of a data processing system in which the illustrative embodiments may be implemented;

FIG. 3 depicts one embodiment of interactive voice response system that credits a customer account for having placed an incoming call from the customer on hold in accordance with the illustrative embodiments;

FIG. 4 depicts an embodiment of a process for crediting a customer account for having placed a call from the customer on hold during a customer service call; and

FIG. 5 depicts an embodiment of a process for crediting a customer account based on advertisements played during a hold period of a customer service call.

### DETAILED DESCRIPTION OF THE DRAWINGS

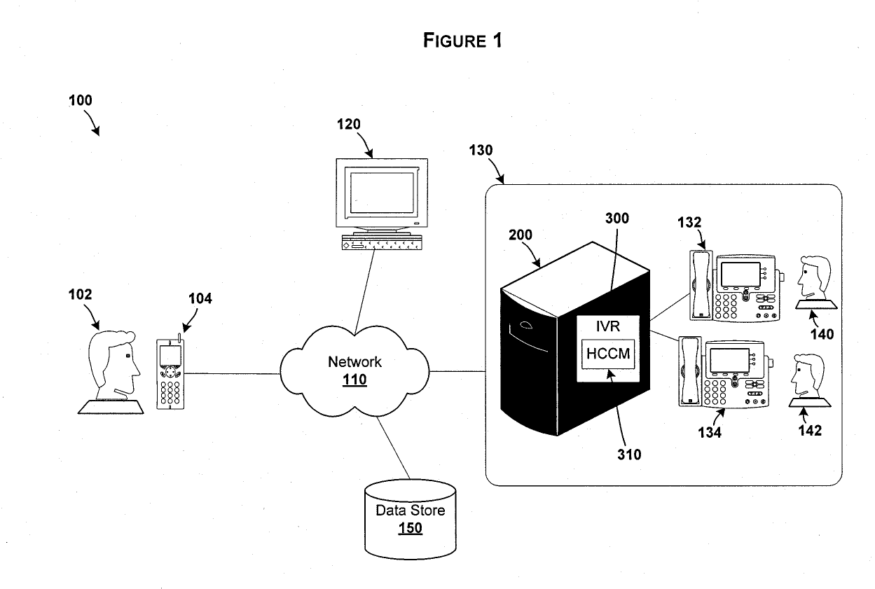

The disclosed embodiments and advantages thereof are best understood by referring to FIGS. 1-5 of the drawings, like numerals being used for like and corresponding parts of the various drawings. Other features and advantages of the disclosed embodiments will be or will become apparent to one of ordinary skill in the art upon examination of the following figures and detailed description. It is intended that all such additional features and advantages be included within the scope of the disclosed embodiments, and protected by the accompanying drawings. Further, the illustrated figures are only exemplary and not intended to assert or imply any limitation with regard to the environment, architecture, or process in which different embodiments may be implemented.

FIG. 1 depicts an embodiment of a network environment 100 in which the illustrative embodiments may be implemented. In the depicted embodiment, a consumer 102 uses a communication device 104 to call a customer service line over network 110. Communication device 104 may be, but is not limited to, a mobile device, a landline telephone, a data processing system, and/or a voice over IP phone.

A customer service line is a telephone number that a consumer calls to receive customer service. In some embodiments, the customer service line is answered at a call center 130. Call center 130 is a centralized office used for the purpose of receiving and transmitting a large volume of requests by telephone. Call center 130 is operated by a company to administer incoming product support or information inquiries from consumers.

In one embodiment, network 110 may include a cellular network, the public switched telephone network (PSTN), and the Internet for connecting communication device 104 to call center 130. PSTN is the network of the world's public circuit-switched telephone network. In some embodiments, the cellular network may include a 3G network. 3G networks are wide-area cellular telephone networks that incorporate high-speed Internet access. The Internet is a global system of interconnected computer networks that interchange data using the standardized Internet Protocol Suite (TCP/IP). The Internet includes millions of private and public networks that are linked by copper wires, fiber-optic cables, wireless connections, and other technologies. In some embodiments, network 110 may also include a number of different types of data networks, such as, but not limited to, an intranet, a local area network (LAN), a wide area network (WAN), and wireless local area network (WLAN) networks.

In some embodiments, a data processing system, such as data processing system 200, answers incoming calls at call center 130. As will be further described, in one embodiment, data processing system 200 executes instructions associated with an interactive voice response (IVR) application 300 for answering incoming customer calls. Additionally, in some embodiments, data processing system 200 executes instructions associated with a hold call credit module 310 for crediting a customer account for having placed a call from the customer on hold during a customer service call.

In some embodiments, data processing system 200 communicates with a plurality of communication devices, such as, but not limited to, telephone 132 and telephone 134 for connecting consumer 102 to a customer representative, such as, customer representative 140 and/or customer representative 142. Additionally, in some embodiments, data processing system 200 may communicate with one or more data processing systems, such as, a server 120 and/or a data store 150. Server 120 may be, but is not limited to, a web server, a database server, a file server, a mail server, and/or an application server. In one embodiment, operational data store 150 is a database that integrates data from multiple sources.

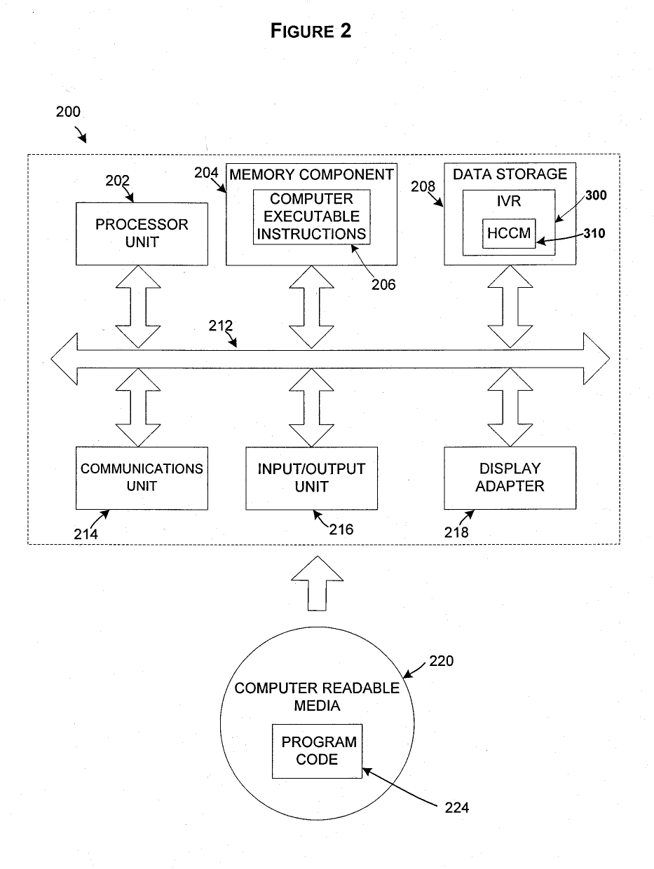

With reference now to FIG. 2, an embodiment of data processing system 200 in which the illustrative embodiments may be implemented is presented. In some embodiments, data processing system 200 may be a server system in a client-server relationship. A server is a data processing system that provides services to other computer programs and their users.

In the illustrative embodiment, data processing system 200 includes, but is not limited to, a processor unit 202, a memory component 204, a data storage 208, a communications unit 214, an input/output (I/O) unit 216, and a display adapter 218. A communications fabric 212 provides conductive pathways/traces to mechanically support and electrically connect the various components of data processing system 200 for enabling data communications between the various components.

Processor unit 202 serves to execute computer executable instructions 206 for software that may be loaded into memory component 204. Processor unit 202 may be a set of one or more processors or may be a multi-processor core, depending on the particular implementation. Further, processor unit 202 may be implemented using one or more heterogeneous processor systems in which a main processor is present with secondary processors on a single chip. In some embodiments, processor unit 202 may be a symmetric multi-processor system containing multiple processors of the same type.

Memory component 204 is a data storage component of data processing system 200. In a preferred embodiment, memory component 204 is volatile memory. Volatile memory is memory that loses its contents when data processing system 200 loses power. For example, in one embodiment, memory component 204 may be random access memory (RAM). Random access memory stores currently executing computer executable instructions 206 and/or data associated with an operating system, hardware device, and/or other software applications, such as, but not limited to, interactive voice response (IVR) application 300 stored in data storage 208. Additionally, in some embodiments, memory component 204 may be embedded memory located on printed circuit board, such as, but not limited to, a motherboard.

Data storage 208 is a non-volatile memory component of data processing system 200. Data storage 208 stores instructions and data for the operating system and other applications/programs. Data storage 208 may take various forms depending on the particular implementation. For example, data storage 208 may contain one or more components or devices, such as, but not limited to, a hard drive, a flash memory, a rewritable optical disk, a rewritable magnetic tape, or some combination of the above. In some embodiments, data storage 208 may be removable, such as, a removable hard drive. Additionally, in some embodiments, data storage 208 may be an external component coupled to data processing system 200, such as, but not limited to, an external hard drive.

Communications unit 214 enables data processing system 200 to communicate with other data processing systems or devices. For example, in one embodiment, communications unit 214 may be a network interface card, such as, but not limited to, an Ethernet card. Alternatively, or in addition to, in some embodiments, communications unit 214 may provide communications through the use of wireless communications links.

Input/output unit 216 allows for input and output of data with other devices that may be connected to data processing system 200. For example, input/output unit 216 may provide a connection for user input through a keyboard and mouse. Further, input/output unit 216 may send output to a printer and/or other connected devices.

Display adapter 218 provides a mechanism to generate and output images to a display. In some embodiments, display adapter 218 may be a dedicated expansion card that is plugged into a slot on the motherboard of data processing system 200 or may a graphics controller integrated into the motherboard chipset. In addition, display adapter 218 may include dedicated memory and one or more processing units.

Program code 224 is located in a functional form on a computer readable media 220. In one embodiment, computer readable media 220 is removable media and may be loaded onto or transferred to data processing system 200 for execution by processor unit 202. Computer readable media 220 may be in a tangible form, such as, but not limited to, an optical or magnetic disc, that is inserted or placed into a drive or other device that is part of data processing system 200 for transferring data and/or executing instructions stored the computer readable media 220. Additionally, computer readable media 220 may also be persistent storage, such as, a hard drive, a thumb drive, or a flash memory that is connected to data processing system 200.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 1 can be varied from the illustrative examples shown.

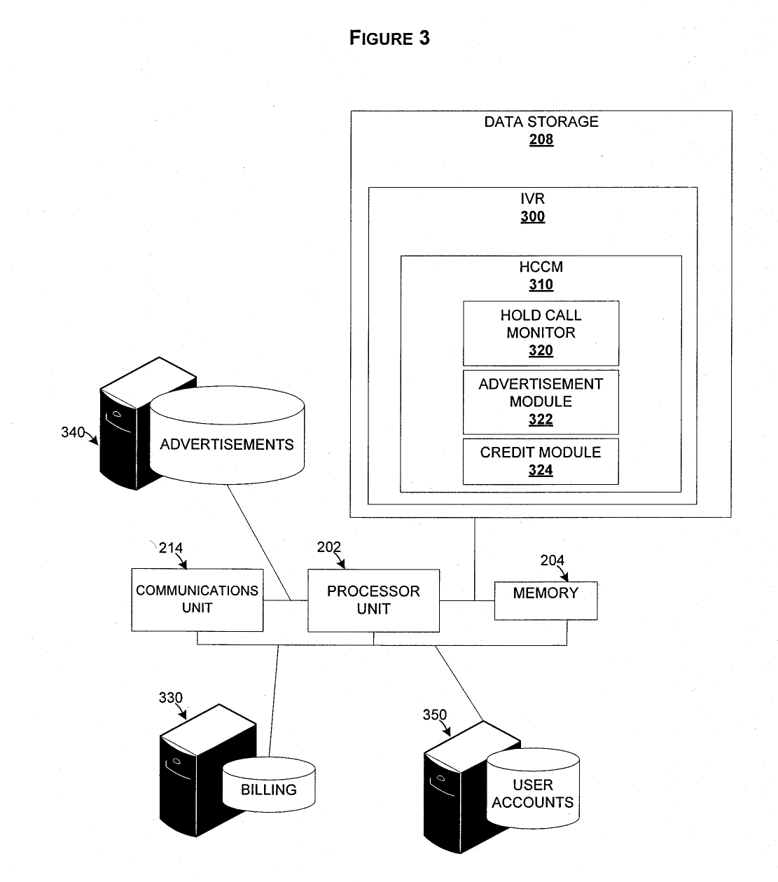

FIG. 3 depicts one embodiment of interactive voice response system 300 that credits a customer account for having placed an incoming call from the customer on hold in accordance with the illustrative embodiments. Interactive voice response system 300 may be stored in data storage 208 and placed into memory component 204 during execution by processor unit 202. Additionally, in some embodiments, the functions associated with interactive voice response system 300 may be implemented in hardware and/or a combination of hardware and software.

In the depicted embodiment, interactive voice response system 300 comprises computer executable instructions for answering an incoming call to a customer service line. For example, in one embodiment, the customer service line is answered at call center 130. In one embodiment, interactive voice response system 300 includes computer executable instructions for presenting an interactive menu that responds with pre-recorded or dynamically generated audio to further direct callers to a desired function/feature. In some embodiments, interactive voice response system 300 detects both voice and keypad inputs.

Additionally, in some embodiments, interactive voice response system 300 may communicate with one or more local or remote databases/database systems, such as, but not limited to, a billing database system 330, an advertisement database system 340, and a user accounts database system 350. For instance, in one embodiment, interactive voice response system 300 uses communications unit 214 to communicate with a remote database system over network 110.

In some embodiments, interactive voice response system 300 may include computer executable instructions to determine a caller identification (ID) of an incoming call and automatically retrieve/pull up a customer account associated with the identified caller ID. For example, in one embodiment, interactive voice response system 300 retrieves the customer account associated with the caller ID from user accounts database system 350. In some embodiments, the customer account may include a demographic profile that may include the name, age, address, occupation, income, marital status, and/or other information associated with the customer.

In addition, in some embodiments, interactive voice response system 300 includes hold call credit module 310 for crediting a customer account for having placed a call from the customer on hold during a customer service call. In accordance with one embodiment, hold call credit module 310 includes a hold call monitor 320, an advertisement module 322, and a credit module 324.

In some embodiments, hold call monitor 320 may include computer executable instructions for monitoring an incoming to determine when the incoming call is placed on a hold state. For example, in some embodiments, hold call monitor 320 may detect when the incoming call is placed in a hold queue while waiting for a live representative to answer the incoming call. In some embodiments, hold call monitor 320 may also detect when a call is placed on a hold state by a live representative. In one embodiment, hold call monitor 320 may simply monitor the time the call is placed on a hold status. In another embodiment, hold call monitor 320 may notify advertising module 322 that the incoming call has been placed on hold.

In one embodiment, advertisement module 322 may include computer executable instructions for retrieving and playing an advertisement to the consumer while the incoming call is placed on a hold status. For example, in some embodiments, advertisement module 322 retrieves an audible advertisement from advertisement database system 340. In some embodiments, advertisement module 322 may retrieve a particular audible advertisement from advertisement database 340 based on the demographic profile of a user and/or based on an area code associated with the caller identification. Additionally, in some embodiments, advertisement module 322 may enable a user to specify a particular language for playing the audible advertisements. Further, in some embodiments, advertisement module 322 may include computer executable instructions to skip an audible advertisement, repeat a current or last played audible advertisement, and/or stop playing of the audible advertisements during the hold state. In some embodiments, the audible advertisement may be interactive. For example, in some embodiments, the audible advertisement may be a survey that requests the user to verbally and/or use the keypad to answer one or more questions.

Credit module 324 includes computer executable instructions for crediting a customer's billing account for having placed a call from the customer on hold during a customer service call. For example, in some embodiments, credit module 324 communicates with billing database system 330 for crediting a customer account based on an amount of time an incoming call was placed on hold. Alternatively, in another embodiment, credit module 324 bases the credit amount on the number of advertisements that were played while the incoming call was placed on hold.

Additionally, in some embodiments, credit module 324 may tie the credit amount to the amount of revenue received from the advertisers of the audible advertisements. For example, in one embodiment, the credit amount may be based on the revenue received for the particular audible advertisements that were played during the hold period. In another embodiment, the credit amount may be based on the revenue received for all audible advertisements. For instance, in one embodiment, the total amount credited to consumers for being placed on hold equals the total amount of revenue received for all audible advertisements. Thus, in one embodiment, the revenue received from the advertisers is offset to the consumers. As an example, in one embodiment, credit module 324 may apply the credit amount after a specified time period, e.g., at the end of the month, by calculating the total advertising revenue received for advertisements played during the specified time period in which an incoming call was received. In embodiments where consumers ate credited based on hold time, credit module 324 may divide the total advertising revenue by a total amount of time associated with the hold status for the specified time period to determine a hold time value factor. To calculate the credit amount for a particular call, credit module 324 multiplies the amount of time the incoming call was placed on hold by the hold time value factor. Alternatively, in embodiments where the consumers are credited based on the number of advertisements played, credit module 324 may divide the total advertising revenue by a total amount of advertisements played during the hold status for the specified time period to determine an advertisement value factor. In these embodiments, to calculate the credit amount for a particular call, credit module 324 multiplies the amount of advertisements played during the hold status for the particular call by the advertisement value factor.

Alternatively, or in addition to, in some embodiments, credit module 324 may base the credit amount on whether a caller participated in answering questions associated with a survey while the incoming call was placed on the hold state. Further, in some embodiments, credit module 324 may determine that the credit value is zero if the incoming call was placed on hold for less than a specified time. For example, in some embodiments, call center 130 may guarantee that all calls will be answered in less than two minutes. Thus, in these embodiments, any call that is placed on a hold status for less than 2 minutes will not receive a hold credit.

Additionally, in some embodiments, if the caller is a new customer, i.e., the caller is not associated with an existing user account, credit module 324 may apply the hold credit to a newly created user account if applicable. Moreover, in some embodiments, credit module 324 may audibly announce a credit amount to the caller just prior to taking the caller off the hold state.

In addition, in some embodiments, the credit may be non-monetary. For example, in some embodiments, other incentives and/or compensation, such as, but not limited to, free services/products or services/products at a reduced cost, may be provided to a user placed on hold.

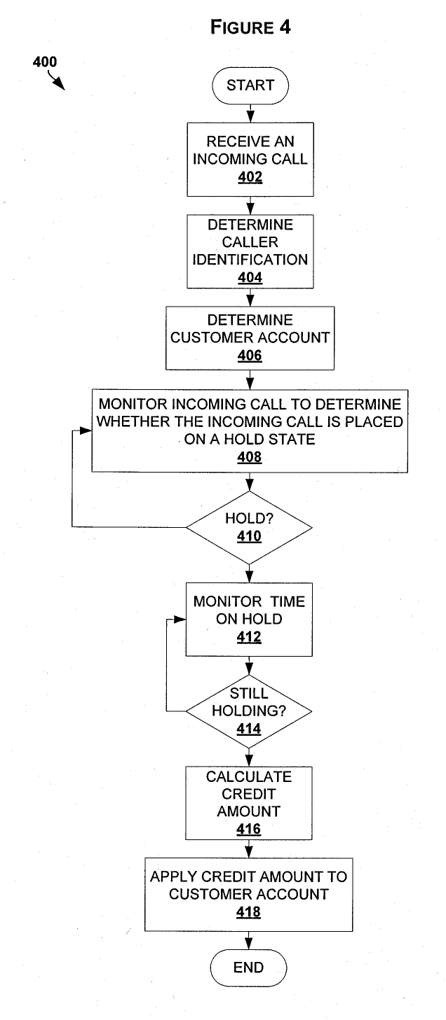

With reference now to FIG. 4, an embodiment of a process is presented for crediting a customer account for having placed a call from the customer on hold during a customer service call. Process 400 may be implemented in a data processing system, such as, but not limited to, data processing system 200. Process 400 begins, at step 402, by receiving an incoming call. At step 404, the process determines the caller ID of the incoming call. The process determines whether a customer account is associated with the caller ID at step 406. For example, in one embodiment, the process queries a user account database for any user account associated with the caller ID. If a user account is found, the process retrieves the user account information. At step 408, the process monitors the incoming call to determine whether the incoming call is placed on a hold state. For instance, the incoming call may be placed in a hold queue awaiting a live representative to be available. If the process determines at step 410 that the call is in a hold state, the process, at step 412, monitors the amount of time the incoming call is placed on hold. Once the process, at step 414, determines that the call is off the hold state, the process, at step 416, calculates a credit amount based on having placed the incoming call on hold. The process applies the credit amount to the customer account, at step 418, with process 400 terminating thereafter.

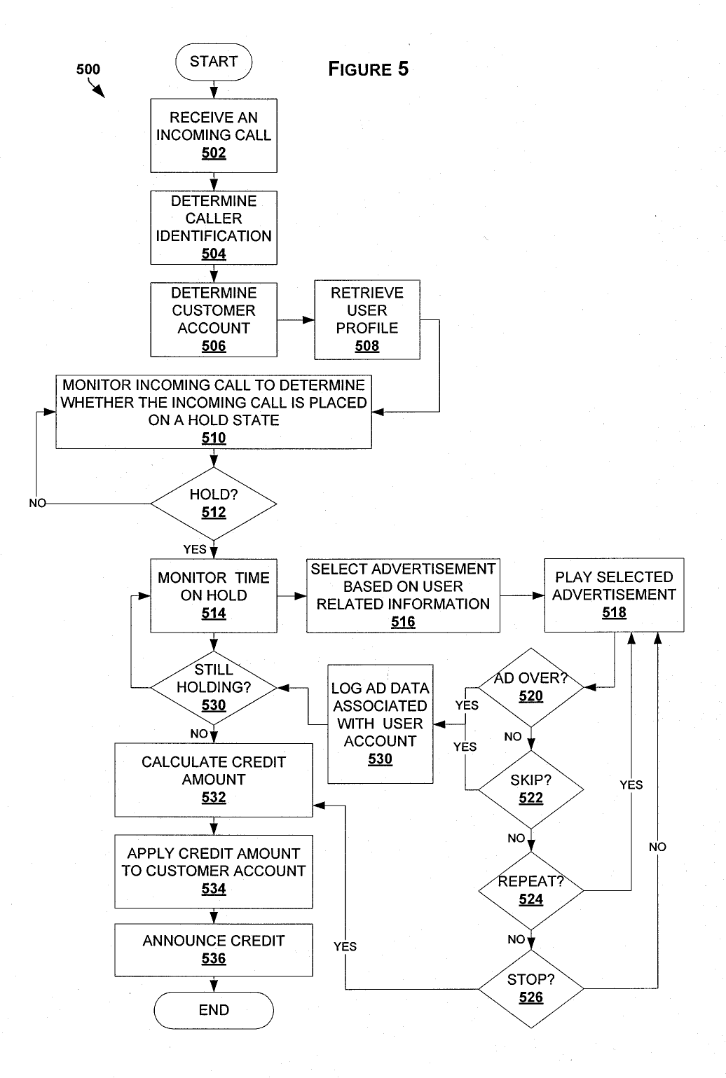

FIG. 5 depicts an embodiment of a process for crediting a customer account based on advertisements played during a hold period of a customer service call. Process 500 begins, at step 502, by receiving an incoming call. At step 504, the process determines the caller ID of the incoming call. The process determines whether a customer account is associated with the caller ID at step 506. At step 508, the process retrieves the user profile associated with a customer account. In one embodiment, the user profile may include the name, age, address, occupation, income, marital status, language preference, and/or other information associated with the customer. At 510, the process monitors the incoming call to determine whether the incoming call is placed on a hold state. In response to a determination, at step 512, that the incoming call is on a hold state, the process monitors the hold time at step 514. At step 516, the process selects an audible advertisement to be played based on user related information, such as, but not limited to, a location of a caller (e.g., using the area code of the caller ID), and/or the age, income, and/or language preference of the caller. At step 518, the process plays the selected audible advertisement while the call is on the hold state.

In some embodiments, process 500, at step 522, enables a user to skip to a next audible advertisement. Additionally, in some embodiments, process 500, at step 524, enables a user to repeat a currently playing and/or last played audible advertisement. Further, in some embodiments, process 500, at step 526, enables a user to stop playing all audible advertisements during the hold state. In one embodiment, process 500 may also include an option to enable a caller to send information associated with an audible advertisement, such as, but not limited to, a link to a website and/or a contact number, to an email address and/or phone number associated with the caller. For example, in some embodiments, process 500 retrieves the caller's email address from the customer account for sending an email to the caller. In another embodiment, process 500 may send a text message to the calling device associated with the identified caller ID.

Once the process, at step 520, determines that an audible advertisement has ended, the process collects the advertisement data in a log file associated with the user account at step 530. For example, in some embodiments, the process logs the particular advertisement that was played and any user interaction (e.g., answers to surveys). If the process determines, at step 530, that the incoming call is still on hold, the process selects another audible advertisement to be played at step 516.

Once the process determines that the incoming call is no longer holding, the process calculates a credit amount at step 532. The process applies to the credit amount to the customer account at step 534. In some embodiments, the process, at step 536, announces the credit amount to the caller prior to transferring the caller to a live representative, with process 500 terminating thereafter.

In summary, embodiments of the disclosed invention include a system and method for crediting a customer account for having placed a call from the customer on hold during a customer service call. For example, in one embodiment, a computer implemented method is presented that includes receiving an incoming call to a customer service line and determining a caller identification associated with the incoming call. The method determines whether the caller identification is associated with a customer account. The method monitors the incoming call to determine whether the incoming call is placed on a hold state. In response to a determination that the incoming call is placed on the hold state; the method initiates a timer to monitor an amount of time the incoming call is placed on the hold state. In response to a determination that the incoming call is taken off the hold state, the method calculates a credit amount based the incoming call having been placed on the hold state. The method applies the credit amount to the customer account.

As will be appreciated by one skilled in the art, the disclosed embodiments may be embodied as a system, method, or computer program product. Accordingly, the disclosed embodiments may be implemented entirely with hardware or as a software embodiment (including firmware, resident software, micro-code, etc.) or an embodiment combining software and hardware aspects that may all generally be referred to herein as a “circuit,” “module” or “system.” Furthermore, the disclosed embodiments may take the form of a computer program product embodied in any tangible medium of expression having computer-usable program code embodied in the medium.

Computer program code for carrying out operations of the present invention may be written in any combination of one or more programming languages, including an object oriented programming language, such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The disclosed embodiments are described above with reference to flowchart illustrations, sequence diagrams, and/or block diagrams. Each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The terminology used herein is for describing particular embodiments only and is not intended to be limiting of the invention. As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, integers, steps, operations, elements, and/or components, but do not preclude the presence or addition of one or more other features, integers, steps, operations, elements, components, and/or groups thereof The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described to explain the principles of the invention and the practical application, and to enable others of ordinary skill in the art to understand the invention for various embodiments with various modifications as are suited to the particular use contemplated.

In addition, the flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which may include one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

We claim:

1. A computer implemented method for crediting a customer account, the computer implemented method comprising:
receiving an incoming call to a customer service line;
determining a caller identification associated with the incoming call;
determining whether the caller identification is associated with a customer account;
monitoring the incoming call to determine whether the incoming call is placed on a hold state;
responsive to a determination that the incoming call is placed on the hold state; initiating a timer to monitor an amount of time the incoming call is placed on the hold state;
responsive to a determination that the incoming call is taken off the hold state, calculating a credit amount based the incoming call having been placed on the hold state; and
applying the credit amount to the customer account.

2. The computer implemented method of claim 1, further comprising playing audible advertisements during the hold state.

3. The computer implemented method of claim 2, wherein the audible advertisements are selected based on an area code associated with the caller identification.

4. The computer implemented method of claim 2, wherein the audible advertisements are selected based on a demographic profile associated with the customer account.

5. The computer implemented method of claim 2, wherein the audible advertisements are in a user-specified language.

6. The computer implemented method of claim 2, further comprising enabling a caller to skip to a next audio advertisement.

7. The computer implemented method of claim 2, further comprising enabling a caller to repeat an audio advertisement.

8. The computer implemented method of claim 2, further comprising enabling a caller to stop playing of the audible advertisements during the hold state.

9. The computer implemented method of claim 1, wherein the credit amount is based on an amount of time the incoming call was placed on the hold state.

10. The computer implemented method of claim 1, wherein the credit amount is based on a number of advertisements that were played while the incoming call was placed on the hold state.

11. The computer implemented method of claim 1, wherein the credit amount is based on a revenue amount associated with each advertisement that was played while the incoming call was placed on the hold state.

12. The computer implemented method of claim 1, wherein the credit amount is based on whether a caller associated with the customer account participated in answering survey questions while the incoming call was placed on the hold state.

13. The computer implemented method of claim 1, wherein calculating the credit amount based the incoming call having been placed on the hold state offsets a revenue amount received for advertisements played during the hold state.

14. The computer implemented method of claim 1, wherein calculating a credit amount based the incoming call having been placed on the hold state further comprises:
calculating a total advertising revenue received for advertisements played during the hold status for a specified time period in which the incoming call was received;
dividing the total advertising revenue by an amount of time associated with the hold status for the specified time period to determine a hold value factor;
multiplying the amount of time the incoming call was placed on the hold state by the hold value factor to determine the credit amount.

15. The computer implemented method of claim 1, wherein the credit amount is zero if the amount of time the incoming call is placed on the hold state is less than a specified time amount.

16. The computer implemented method of claim 1, further comprising responsive to a determination that the caller identification is not associated with any customer account, applying the credit amount to a newly created customer account.

17. The computer implemented method of claim 1, further comprising audibly announcing the credit amount to a calling party.

18. The computer implemented method of claim 1, wherein the credit amount is non-monetary.

19. An interactive voice response system comprising:
a memory component for storing computer executable instructions;
a data storage unit for storing audible advertisements;
a network interface for receiving incoming call;
a processing unit that executes the computer executable instructions to:
answer the incoming call;
determine a caller identification associated with the incoming call;
determine whether the caller identification is associated with a customer account;
monitor the incoming call to determine whether the incoming call is placed on a hold state;
initiate a timer to monitor an amount of time the incoming call is placed on the hold state;
calculate a credit amount based the amount of time the incoming call was placed on the hold state; and
apply the credit amount to the customer account.

20. A computer readable media comprising computer usable program code that:
calculates revenues received from advertisers associated with audible advertisements that are played during a hold state of a telephone call; and
credits a customer account associated with a caller of the telephone call using the revenues received from the advertisers, wherein the credit offsets the revenues.
